(19) United States
(12) Patent Application Publication
(10) Pub. No.: US 2022/0152674 A1
(43) Pub. Date: May 19, 2022

(54) ENDLESS HOT-ROLLED STRIP PRODUCTION DEVICE AND METHOD FOR FERRITE ROLLING

(71) Applicant: WUHAN IRON AND STEEL COMPANY LIMITED, Hubei (CN)

(72) Inventors: Shuize WANG, Hubei (CN); Xinping MAO, Hubei (CN); Zhen CAI, Hubei (CN); Cheng WANG, Hubei (CN); Jiamei TAN, Hubei (CN)

(73) Assignee: WUHAN IRON AND STEEL COMPANY LIMITED, Hubei (CN)

(21) Appl. No.: 17/431,427

(22) PCT Filed: Aug. 14, 2020
(86) PCT No.: PCT/CN2020/109076

§ 371 Date: Aug. 17, 2021

(30) Foreign Application Priority Data
Aug. 15, 2019 (CN) 201910753893.X

(51) Int. Cl. B21B 1/46; B21B 37/74; B21B 45/06; B21B 45/08

(52) U.S. Cl. CPC B21B 1/463; B21B 37/74; B21B 2201/04; B21B 45/08; B21B 45/06

(57) ABSTRACT

The device has a short production line, and all components are reasonably configured. A multifunctional cooling control device is adopted to integrate high-pressure water descaling and intermediate billet cooling functions, which is simpler and more efficient. Layout of a 4R+(3−4)F rolling mill, four thermos-detectors and short-distance underground coilers are use. The method includes the steps: carrying out continuous casting to manufacture a slab, high-pressure water rotating descaling, rough rolling by a four-stand high reduction rough rolling unit, machining by a drum shear, cooling after high-pressure water descaling in the multifunctional cooling control device, finish rolling by a three-stand or four-stand finish rolling unit, air cooling, dividing coils by a high-speed flying shear, and coiling by underground coilers, wherein temperature monitoring is respectively carried out after rough rolling, before finish rolling, after finish rolling, and before coiling by the underground coiler.

### BACKGROUND

### Technical Field

The present disclosure belongs to an endless hot-rolled strip production device and method, and in particular relates to an endless hot-rolled strip production device and method for ferrite rolling.

### Description of Related Art

Ferrite rolling is a new technology proposed by a professor Appell of Belgium in the mid-1970s. The technology was originally aimed at simplifying the process and saving energy. Traditional continuously casting slabs are used as raw materials to produce, via ferrite rolling, a cheap, soft and non-aging hot-rolled plate that can be used directly or later for cold-rolled production. Since low carbon and ultra-low carbon steel has a relatively large ferrite region range and high temperature, the current ferrite rolling technology is mainly used for production of low carbon and ultra-low carbon steel.

Due to limitations on equipment capabilities and process characteristics, the ferrite rolling process based on the traditional hot rolling process produces low carbon and ultra-low carbon steel of which the thickness is generally 2.5 mm or above, and mainly provides hot-rolled raw materials for subsequent cold rolling. Meanwhile, since the production line is mainly designed for the traditional austenitic rolling process, it is difficult to implement the ferrite rolling process. Technological characteristics of a thin slab continuous casting and continuous rolling process make it possible to directly produce a hot-rolled strip product of low carbon and ultra-low carbon of which the thickness is 2.0 mm or below, realizing “replacing a cold rolled product by hot rolled one”. Emergence of an endless rolling technology represented by an ESP technology has further enhanced batch and stabilized manufacturing capacities of thin hot-rolled strip. However, due to the fine grain characteristics of products of thin slab continuous casting and continuous rolling process, a problem of a high strength generally exists in the production of low carbon and ultra-low carbon steel, which greatly affects formability of materials. Ferrite rolling can coarsen grains to a certain extent, and is an effective method to improve the high strength of low carbon and ultra-low carbon steel produced by the thin slab continuous casting and continuous rolling process. However, the existing thin slab continuous casting and continuous rolling production lines including CSP and ESP are still mainly designed according to the traditional austenitic rolling process, and the ferrite rolling process is difficult to implement. In order to realize ferrite rolling on the traditional thin slab continuous casting and continuous rolling production lines, the patent CN106244921B proposes a method for producing low carbon steel by using a ferrite rolling process on a CSP production line, the key process points are that F1, F2, F4, F5, F6 and F7 in a seven-stand finish rolling mill are adopted for rolling, an F3 stand is dummy, cooling water between the F1-F3 stands is 60-90%, and pure ferrite rolling is achieved at F4 via cooling between stands. After adopting the ferrite rolling process, the strength of the materials is obviously reduced and the formability is improved. The patents CN201810657331 and CN201610768866 propose a method for producing low carbon steel by using ferrite rolling on an ESP production line, the key control points are to cool, by cooling water, an intermediate billet that enters between the first stand and the second stand and between the second stand and the third stand, so that the billet has been transformed from austenite to ferrite before entering the third stand, and when the billet is rolled between from the third stand to the fifth stand, the billet is in the ferrite region so as to achieve the ferrite rolling. Since it is difficult to control the temperature of the billet between stands by using water cooling and to ensure precision, the patent CN201721755853 proposes a ferrite rolling control system, and the key point of the process is to use a tunnel-type soaking furnace between rough rolling and finish rolling to achieve a uniform control of the temperature. In addition, the patents CN201710960186 and CN201710960187 also propose a ferrite rolling method and device for low-micro carbon steel for deep drawing and ultra-low carbon steel for ultra-deep drawing by endless continuous casting and continuous rolling, adopt new layouts, make partial improvements, but cannot fully meet, in the aspect of layouts of the rolling mills, the setting of the intermediate billet cooling device, the setting of the coilers, and the precise detection and control of temperature in the entire process, the requirements of ferrite rolling, including high control precision of the temperature of the intermediate billet, as well as strict temperature control requirements “one low and two high” in the finish rolling process and coiling process, i.e., a low start rolling temperature of finish rolling and a high finish rolling temperature and a high coiling temperature are adopted, so as to meet process requirements for recrystallization and recovery of an internal structure of a ferrite rolled product.

### SUMMARY

The objective of the present disclosure is to provide an endless hot-rolled strip production device and method for ferrite rolling of low carbon and ultra-low carbon steel. The device achieves a short production line, a reasonable configuration of all components and a precise temperature control. By using the device for ferrite rolling, the product quality is high, and production cost and energy consumption are low.

In order to achieve the above objective, the technical solution provided by the present disclosure is as follows:

An endless hot-rolled strip production device for ferrite rolling is provided, which includes a continuous casting machine, a high-pressure water rotating descaling device, a four-stand high reduction rough rolling unit, a drum shear, thermo-detectors, a multifunctional cooling control device, a three-stand or four-stand finish rolling unit, a high-speed flying shear, and underground coilers, wherein,

the number of the thermo-detectors is four, and the thermo-detectors are respectively arranged behind the four-stand high reduction rough rolling unit, in front of and behind the three-stand or four-stand finish rolling unit, and in front of the underground coilers;

all components are connected in sequence.

According to the above solution, the multifunctional cooling control device has a length of 5-10 m, preferably 5-7 m, and is divided into two sections, the front section being a high-pressure water descaling device and the rear section being a water-cooling or mist cooling device.

According to the above solution, the underground coilers are two conventional underground coilers, wherein a distance L1 from the last finish rolling stand to the first coiler is 10-45 m, preferably 15-30 m, and a distance L2 from the last finish rolling stand to the second coiler is 15-50 m, preferably 20-35 m; and the underground coilers are one rotating two-reel coiler, and a distance from the underground coiler to the last finish rolling stand is 10-50 m, preferably 15-30 m.

An endless hot-rolled strip production method for ferrite rolling using the device is provided, and the production process includes the steps of carrying out continuous casting to manufacture a slab, high-pressure water rotating descaling, rough rolling by the four-stand high reduction rough rolling unit, machining by the drum shear, cooling after high-pressure descaling in the multifunctional cooling control device, finish rolling by the three-stand or four-stand finish rolling unit, air cooling, dividing coils by the high-speed flying shear, and coiling by the underground coilers, wherein temperature monitoring is respectively carried out after rough rolling, before finish rolling, after finish rolling, and before coiling by the underground coilers.

According to the above solution, a temperature at an entrance of rough rolling of the continuously casting slab is 1050-1250° C. and a temperature at an exit of rough rolling is 950-1000° C., an intermediate billet after rough rolling is cooled by the multifunctional cooling control device at a cooling speed of 20-50° C./s, a temperature at an entrance of finish rolling is 780-880° C. and a temperature at an exit of finish rolling is 700-800° C., and after air cooling, a coiling temperature is 650-750° C.; and after being unloaded from the coilers, steel coils are thermally insulated with an on-line thermal insulation cover, or are quickly sent to a thermal insulation pit until the temperature drops 550° C. or below, preferably 450° C. or below.

According to the above solution, a reduction rate of each stand of the rough rolling unit is 40%-60% and a speed at an exit of rough rolling is 0.5-2.0 m/s; a reduction rate of the first two stands of the three-stand or four-stand finish rolling unit is 40%-60% and a reduction rate of the last stand is 10-25%, wherein a reduction rate of the third stand is 20-45% when the finish rolling unit is a four-stand finish rolling unit, and the finish rolling unit adopts lubrication rolling.

According to the above solution, a descaling pressure for the high-pressure water rotating descaling before rough rolling and a descaling pressure for the high-pressure water descaling in the multifunctional cooling control device before finish rolling are both 20-40 MPa.

According to the above solution, a thickness range of the continuously casting slab is 70-130 mm, and a drawing speed of the continuous casting is 4.5-7.0 m/min; a thickness of the intermediate billet at the exit of rough rolling is 5-15 mm; and a thickness of a finished product is 0.6-3.0 mm.

According to the above solution, in the endless hot-rolled strip production method for ferrite rolling, strip applicable is low carbon or ultra-low carbon steel with C≤0.05%, Si≤0.10% and Mn≤0.20% in terms of percentage content.

The present disclosure provides an endless hot-rolled strip production device for ferrite rolling, specifically designs the production device mainly for the process requirements for ferrite rolling, and omits some unnecessary devices in the traditional hot-rolling process and the thin slab continuous casting and continuous rolling process, such as heating furnaces, electromagnetic induction devices and laminar cooling devices. In addition, the present disclosure adopts the multifunctional cooling control device to integrate the high-pressure water descaling function and the intermediate billet cooling function, making the device production line simpler and more efficient. The present disclosure adopts the layout of the 4R+(3−4)F rolling mill, the four thermo-detectors and the short-distance underground coilers, which not only reduces a cooling load of the intermediate billet but also is more beneficial to realize a precise temperature control of the entire rolling process, thereby improving the product quality. The traditional hot rolling process has a production line of which the length is about 1000 m, a typical thin slab continuous casting and continuous rolling process, e.g., the CSP production line, has a production line of which the length is about 400 m, and the ESP production line has a length of about 180 m. In the endless hot-rolled strip production device for ferrite rolling designed in the present disclosure, the length of the production line is about 120-150 m, the production line is shorter, and configuration of the components is more reasonable.

In the endless hot-rolled strip production method for ferrite rolling provided by the present disclosure, the process temperature drop of the slab is reasonably used in the entire process of hot rolling without a need to heat or reheat the intermediate billet, and requirements for cooling controlling capability of the intermediate billet are relatively low, which can greatly reduce energy consumption and water consumption of the manufacturing process, and is energy-saving, green, and environmentally friendly.

The layout of the rolling mills adopted by the present disclosure is more beneficial for realization of the ferrite rolling process. The present disclosure adopts the layout of the 4R+(3−4)F rolling mill, and has the following advantages: 1) in order to ensure the process requirements “a low start rolling temperature of finish rolling and a high finish rolling temperature” for ferrite rolling, it is required to reduce the temperature drop during finish rolling as much as possible, and thus a reduction in the number of the stands of the finish rolling unit will be required. However, on the other hand, in order to obtain more favorable deformation textures, the ferrite rolling technology requires that the strip should have sufficient accumulated deformation when being rolled in the ferrite region, and thus the number of the finish rolling stands should not be too small. The layout of the three-stand or four-stand finish rolling unit proposed by the present disclosure is a technical solution that can meet requirements for various aspects of the ferrite rolling; and 2) the layout of the rough rolling unit is set to four stands, which can further reduce the thickness of the intermediate billet. A reduction in the thickness of the intermediate billet can reduce requirements for a rolling load of the finish rolling unit, and more importantly, can make the temperature of the intermediate billet closer to requirements for the temperature of ferrite rolling, thereby reducing requirements for the cooling capacity of the intermediate billet cooling control device.

The present disclosure first carries out descaling and then cooling before finish rolling by means of the multifunctional cooling control device, which can better control the temperature at the entrance of finish rolling.

In the present disclosure, four high-precision thermo-detectors are arranged behind the rough rolling mill, in front of the finish rolling mill, behind the finish rolling mill and in front of the coiler, which can precisely detect the temperature of the strip and make a timely feedback control at any time to ensure precision of temperature control required at all the stages of the rolling process.

According to the disclosure, by adopting the short-distance underground coiler, the temperature drop of the strip may be reduced as much as possible during the conveying process. Meanwhile, after being unloaded from the coilers, the steel coils are thermally insulated with an online thermal insulation cover or quickly enter a thermal insulation pit so as to fully recover and recrystallize the deformed microstructure of the strip, and at the same time avoid performance incompatibility caused by rapid cooling of head and tail of the steel coils during air cooling, which is beneficial to obtain a good product quality and better meet the performance requirements “replacing a cold rolled product by hot rolled one”.

The beneficial effects of the present disclosure are as follows:

(1) In the endless hot-rolled strip production device for ferrite rolling provided by the present disclosure, the production device is specifically designed mainly for the process requirements for ferrite rolling, the device has a short production line which is 120-150 m in length, a reasonable configuration of all components and a precise temperature control, and rolling costs and energy consumption are low.

(2) In the endless hot-rolled strip production method for ferrite rolling provided by the present disclosure, by adopting the layout of the 4R+(3−4)F rolling mill, the process temperature drop of the slab is reasonably used during the entire process of hot rolling without a need to heat or reheat the intermediate billet, and the requirements for cooling control capability are relatively low, which can greatly reduce the energy consumption and water consumption during the manufacturing process. Four high-precision thermo-detectors are arranged behind the rough rolling mill, in front of the finish rolling mill, behind the finish rolling mill and in front of the coiler to achieve a precise control of the temperature during the entire process and make a timely adjustment so as to meet precise requirements for the temperature at different rolling stages. By first carrying out descaling and then cooling before finish rolling, the temperature at the entrance of finish rolling can be controlled more precisely. By adopting the short-distance coiling process and making a timely thermal insulation treatment after unloading the steel coils, it is ensured to reduce the temperature drop of the strip as much as possible during the delivering process, so that the deformed microstructure of the strip can be fully recovered and recrystallized, and meanwhile, the problem on performance incompatibility caused by rapid cooling of head and tail of the steel coils during air cooling can be avoided, which is beneficial to obtain a good product quality. By using the endless hot-rolled strip production method for ferrite rolling provided by the present disclosure, the energy consumption and the cost are low, the product has a good quality and a thin thickness, so that the performance requirements “replacing a cold rolled product by hot rolled one” may be better met.

### BRIEF DESCRIPTION OF THE DRAWINGS

FIG. 1 is an endless hot-rolled strip production device for ferrite rolling according to an embodiment of the present disclosure, wherein the reference sign “1” represents a continuous casting machine, “2” represents a high-pressure water rotating descaling device, “3” represents a four-stand high reduction rough rolling unit, “4” represents a drum shear, “5a”, “5b”, “5c” and “5d” represent thermo-detectors, “6” represents a multifunctional cooling control device, “7” represents a three-stand or four-stand finish rolling unit, “8” represents a high-speed flying shear, “9a” and “9b” represent underground coilers, L1 is a distance from the last finish rolling stand to the first coiler, and L2 is a distance from the last finish rolling stand to the second coiler

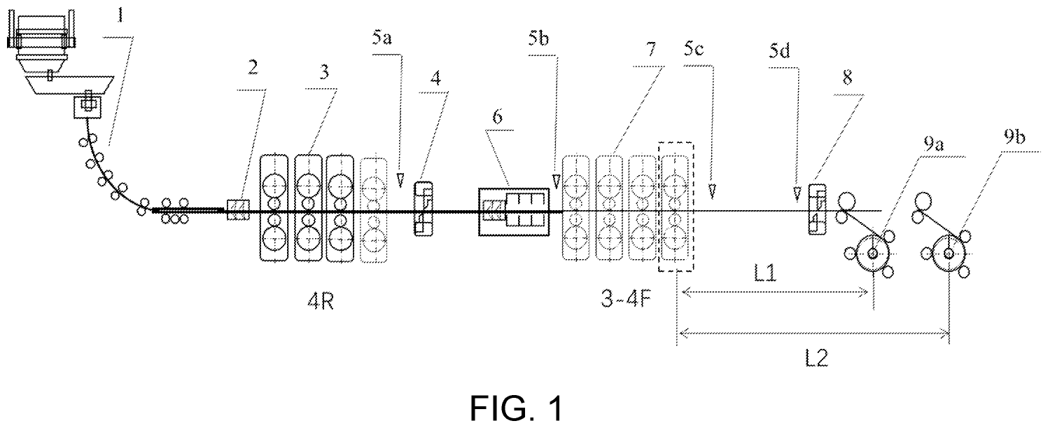

FIG. 2 is a schematic diagram of key process points of an endless hot-rolled strip production method for ferrite rolling according to an embodiment of the present disclosure.

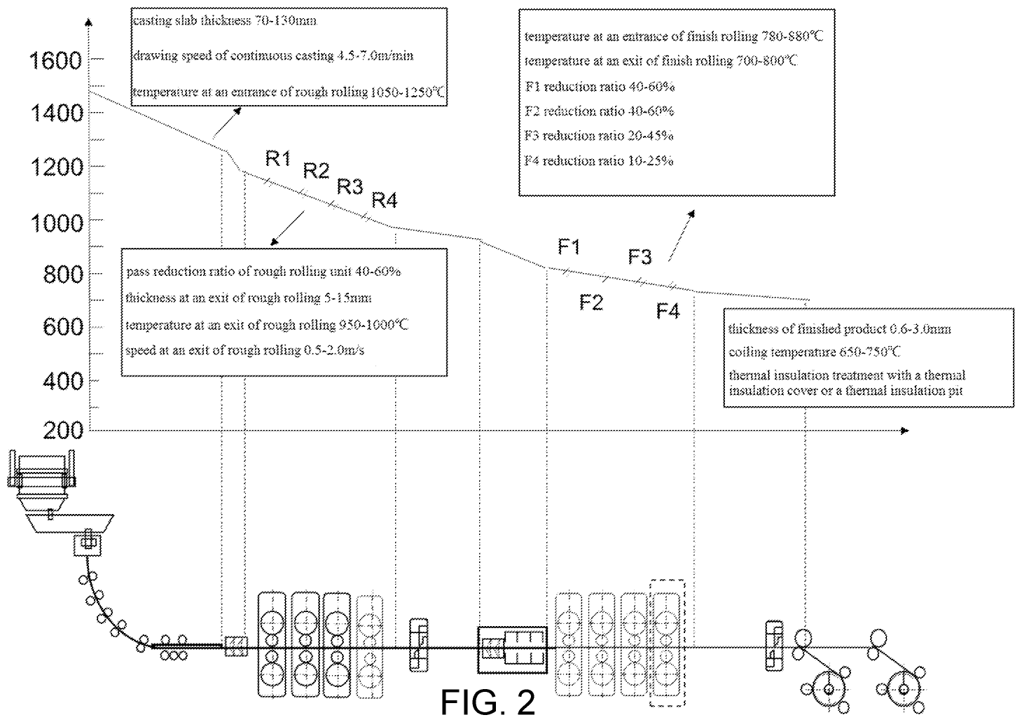

### DESCRIPTION OF THE EMBODIMENTS

The present disclosure will be further described in detail below with reference to specific embodiments.

### Embodiment 1

The following chemical components and mass percent of low carbon steel are adopted: C: 0.05%, Si: 0.10%, Mn: 0.20%, P: 0.010%, S: 0.005%, N: 0.0040%, and the balance being Fe. A thickness of a continuously casting slab is 130 mm, a drawing speed is 4.5 m/min, a slab exits a continuous casting machine and then is subjected to high-pressure water rotating descaling at a descaling pressure of 20 MPa, and then directly enters a four-stand high reduction rough rolling unit for rolling (a reduction rate is 50%, 50%, 40% and 40%, respectively), a temperature of the slab before rough rolling is 1080° C., an intermediate billet after rough rolling has a thickness of 11.7 mm, an exit speed of 0.83 m/s and an exit temperature of 950° C., the intermediate billet enters a multifunctional cooling control device for high-pressure water descaling and controlled cooling, a length of the multifunctional cooling control device is 7 m, a high-pressure water descaling pressure is 35 MPa, and a cooling speed of a cooling section is 30° C. Is, a temperature of the intermediate billet before entering the finish rolling mill is 810° C., and then finish rolling by four stands is carried out (a reduction rate is 50%, 40%, 30% and 15%, respectively). Each stand of the finish rolling adopts lubrication rolling. The thickness of the strip at the exit is 2.0 mm, the final rolling temperature is 740° C., and an air cooling mode is adopted after the strip exits the finish rolling. The underground coilers are two conventional underground coilers, a distance L1 from the last finish rolling stand to the first coiler is 15 m, and the strip enters the first underground coiler to be coiled after delivering for 15 m on a runout table, and the coiling temperature is 710° C. A high-speed flying shear shears the steel coils according to requirements for weight of the strip coils, the sheared coils are unloaded and then thermally insulated with a thermal insulation cover, and when the temperature slowly drops 550° C. or below, the coils are naturally air cooled. By using the above process, the material performance meets standard requirements.

### Embodiment 2

The following chemical components and mass percent of low carbon steel are adopted: C: 0.025%, Si: 0.07%, Mn: 0.10%, P: 0.010%, S: 0.004%, N: 0.0045%, and the balance being Fe. A thickness of a continuously casting slab is 70 mm, a drawing speed is 7 m/min, a slab exits a continuous casting machine and then is subjected to high-pressure water rotating descaling at a descaling pressure of 40 MPa, and then directly enters a four-stand high reduction rough rolling unit for rolling, a temperature of the slab before rough rolling is 1150° C., an intermediate billet after rough rolling has a thickness of 5 mm (a reduction rate is 60%, 50%, 40% and 40%, respectively), an exit speed of 1.6 m/s and an exit temperature of 980° C., the intermediate billet enters a multifunctional cooling control device for high-pressure water descaling and controlled cooling, a length of the multifunctional cooling control device is 5 m, a high-pressure water descaling pressure is 36 MPa, and a cooling speed of a cooling section is 35° C./s, a temperature of the intermediate billet before entering the finish rolling mill is 820° C., and then finish rolling by three stands is carried out (a reduction rate is 53%, 48% and 15%, respectively). Each stand of the finish rolling adopts lubrication rolling. The thickness of the strip at the exit is 1.0 mm, the final rolling temperature is 750° C., and an air cooling mode is adopted after the strip exits the finish rolling. The underground coilers are two conventional underground coilers, a distance L2 from the last finish rolling stand to the second coiler is 30 m, and the strip enters the second underground coiler to be coiled after delivering for 30 m on a runout table, and the coiling temperature is 700° C. A high-speed flying shear shears the coils according to requirements for weight of the strip coils, the sheared coils are unloaded and then sent to a thermal insulation pit for thermal insulation, and when the temperature slowly drops 450° C. or below, the coils are naturally air cooled.

### Embodiment 3

The following chemical conponents and mass percent of ultra-low carbon steel are adopted: C: 0.0035%, Si: 0.03%, Mn: 0.08%, P: 0.009%, S: 0.003%, N: 0.0040%, and the balance being Fe. A thickness of a continuously casting slab is 110 mm, a drawing speed is 5.5 m/min, a slab exits a continuous casting machine and then is subjected to high-pressure water rotating descaling at a descaling pressure of 25 MPa, and then directly enters a four-stand high reduction rough rolling unit for rolling (a reduction rate is 55%, 50%, 46% and 40%, respectively), a temperature of the slab before rough rolling is 1200° C., an intermediate billet after rough rolling has a thickness of 8 mm, an exit speed of 1.26 m/s and an exit temperature of 970° C., the intermediate billet enters a multifunctional cooling control device for high-pressure water descaling and controlled cooling, a length of the multifunctional cooling control device is 7 m, a high-pressure water descaling pressure is 32 MPa, and a cooling speed of a cooling section is 30° C./s, a temperature of the intermediate billet before entering the finish rolling mill is 860° C., and then finish rolling by four stands is carried out (a reduction rate is 55%, 50%, 45% and 15%, respectively). Each stand of the finish rolling adopts lubrication rolling. The thickness of the strip at the exit is 0.8 mm, the final rolling temperature is 780° C., and an air cooling mode is adopted after the strip exits the finish rolling. The underground coilers are one rotating two-reel coiler, a distance from the last finish rolling stand to the coiler is 20 m, and the strip enters the rotating two-reel coiler to be coiled after delivering for 20 m on a runout table, and the coiling temperature is 730° C. A high-speed flying shear shears the coils according to requirements for weight of the strip coils, the sheared coils are unloaded and then sent to a thermal insulation cover for thermal insulation, and when the temperature slowly drops 350° C. or below, the coils are naturally air cooled.

### Embodiment 4

The following chemical components and mass percent of ultra-low carbon steel are adopted: C: 0.0015%, Si: 0.05%, Mn: 0.10%, P: 0.008%, S: 0.004%, N: 0.0035%, and the balance being Fe. A thickness of a continuously casting slab is 100 mm, a drawing speed is 6.0 m/min, a slab exits a continuous casting machine and then is subjected to high-pressure water rotating descaling at a descaling pressure of 35 MPa, and then directly enters a four-stand high reduction rough rolling unit for rolling (a reduction rate is 55%, 50%, 48% and 40%, respectively), a temperature of the slab before rough rolling is 1250° C., an intermediate billet after rough rolling has a thickness of 7 mm, an exit speed of 1.43 m/s and an exit temperature of 1000° C., the intermediate billet enters a multifunctional cooling control device for high-pressure water descaling and controlled cooling, a length of the multifunctional cooling control device is 7 m, a high-pressure water descaling pressure is 34 MPa, and a cooling speed of a cooling section is 30° C./s, a temperature of the intermediate billet before entering the finish rolling mill is 870° C., and then finish rolling by three stands is carried out (a reduction rate is 55%, 45% and 13%, respectively). Each stand of the finish rolling adopts lubrication rolling. The thickness of the strip at the exit is 1.5 mm, the final rolling temperature is 800° C., and an air cooling mode is adopted after the strip exits the finish rolling. The underground coilers are two conventional underground coilers, a distance L1 from the last finish rolling stand to the first coiler is 30 m, and the strip enters the first underground coiler to be coiled after delivering for 30m on a runout table, and the coiling temperature is 720° C. A high-speed flying shear shears the coils according to requirements for weight of the strip coils, the sheared coils are unloaded and then sent to a thermal insulation cover for thermal insulation, and when the temperature slowly drops 400° C. or below, the coils are naturally air cooled.

### Embodiment 5

The following chemical components and mass percent of ultra-low carbon steel are adopted: C: 0.0010%, Si: 0.035%, Mn: 0.08%, P: 0.008%, S: 0.004%, N: 0.0035%, and the balance being Fe. A thickness of a continuously casting slab is 120 mm, a drawing speed is 5.0 m/min, a slab exits a continuous casting machine and then is subjected to high-pressure water rotating descaling at a descaling pressure of 25 MPa, and then directly enters a four-stand high reduction rough rolling unit for rolling (a reduction rate is 50%, 50%, 45% and 40%, respectively), a temperature of the slab before rough rolling is 1130° C., an intermediate billet after rough rolling has a thickness of 10 mm, an exit speed of 1 m/s and an exit temperature of 980° C., the intermediate billet enters a multifunctional cooling control device for high-pressure water descaling and controlled cooling, a length of the multifunctional cooling control device is 7 m, a high-pressure water descaling pressure is 36 MPa, and a cooling speed of a cooling section is 25° C./s, a temperature of the intermediate billet before entering the finish rolling mill is 880° C., and then finish rolling by four stands is carried out (a reduction rate is 55%, 45%, 25% and 13%, respectively). Each stand of the finish rolling adopts lubrication rolling. The thickness of the strip at the exit is 1.6 mm, the final rolling temperature is 790° C., and an air cooling mode is adopted after the strip exits the finish rolling. The underground coilers are two conventional underground coilers, a distance L2 from the last finish rolling stand to the second coiler is 35 m, and the strip enters the second underground coiler to be coiled after delivering for 35 m on a runout table, and the coiling temperature is 720° C. A high-speed flying shear shears the coils according to requirements for weight of the strip coils, the sheared coils are unloaded and then sent to a thermal insulation cover for thermal insulation, and when the temperature slowly drops 450° C. or below, the coils are naturally air cooled.

1. An endless hot-rolled strip production device for ferrite rolling, comprising a continuous casting machine, a high-pressure water rotating descaling device, a four-stand high reduction rough rolling unit, a drum shear, thermo-detectors, a multifunctional cooling control device, a three-stand or four-stand finish rolling unit, a high-speed flying shear, and underground coilers, wherein,
the number of the thermo-detectors is four, and the thermo-detectors are respectively arranged behind the four-stand high reduction rough rolling unit, in front of and behind the three-stand or four-stand finish rolling unit, and in front of the underground coilers; and
all components are connected in sequence.

2. The endless hot-rolled strip production device for ferrite rolling according to claim 1, wherein the multifunctional cooling control device has a length of 5 m-10 m and is divided into two sections, the front section being a high-pressure water descaling device and the rear section being a water-cooling or mist cooling device.

3. The endless hot-rolled strip production device for ferrite rolling according to claim 1, wherein the underground coilers are two conventional underground coilers, wherein a distance from a last finish rolling stand to the first coiler is 10 m-45 m, and a distance from the last finish rolling stand to the second coiler is 15 m-50 m; and the underground coilers can also adopt one rotating two-reel coiler, and a distance from the underground coiler to the last finish rolling stand is 10 m-50 m.

4. The endless hot-rolled strip production device for ferrite rolling according to claim 3, wherein the underground coilers are two conventional underground coilers, wherein the distance from the last finish rolling stand to the first coiler is 15 m-30 m, and the distance from the last finish rolling stand to the second coiler is 20 m-35 m; and the underground coilers can also adopt one rotating two-reel coiler, and the distance from the underground coiler to the last finish rolling stand is 15 m-30 m.

5. An endless hot-rolled strip production method for ferrite rolling using the device according to claim 1, wherein the production process comprises the steps of carrying out continuous casting to manufacture a slab, high-pressure water rotating descaling, rough rolling by the four-stand high reduction rough rolling unit, machining by the drum shear, cooling after high-pressure water descaling in the multifunctional cooling control device, finish rolling by the three-stand or four-stand finish rolling unit, air cooling, dividing coils by the high-speed flying shear, and coiling by the underground coilers, wherein temperature monitoring is respectively carried out after rough rolling, before finish rolling, after finish rolling, and before coiling by the underground coilers.

6. The endless hot-rolled strip production method for ferrite rolling according to claim 5, wherein a temperature at an entrance of rough rolling of a continuously casting slab is 1050° C.-1250° C. and a temperature at an exit of rough rolling is 950° C.-1000° C., an intermediate billet after rough rolling is cooled by the multifunctional cooling control device at a cooling speed of 20° C./s-50° C./s, a temperature at an entrance of finish rolling is 780° C.-880° C., a temperature at an exit of finish rolling is 700° C.-800° C., and after air cooling, a coiling temperature is 650° C.-750° C.; and after being unloaded from the coilers, steel coils are thermally insulated with an on-line thermal insulation cover, or quickly sent to a thermal insulation pit until the temperature drops below 550° C.

7. The endless hot-rolled strip production method for ferrite rolling according to claim 5, wherein a reduction rate of each stand of the rough rolling unit is 40%-60% and a speed at the exit of rough rolling is 0.5 m/s-2.0 m/s; a reduction rate of the first two stands of the three-stand or four-stand finish rolling unit is 40%-60% and a reduction rate of the last stand is 10%-25%, wherein a reduction rate of the third stand is 20%-45% when the finish rolling unit is a four-stand finish rolling unit; and the finish rolling unit adopts lubrication rolling.

8. The endless hot-rolled strip production method for ferrite rolling according to claim 5, wherein a descaling pressure for the high-pressure water rotating descaling before rough rolling and a descaling pressure for the high-pressure water descaling in the multifunctional cooling control device before finish rolling are both 20 MPa-40 MPa.

9. The endless hot-rolled strip production method for ferrite rolling according to claim 5, wherein a thickness range of the continuously casting slab is 70 mm-130 mm, and a drawing speed of the continuous casting is 4.5 m/min-7.0 m/min; a thickness of the intermediate billet at the exit of rough rolling is 5 mm-15 mm; and a thickness of a finished product is 0.6 mm-3.0 mm.

10. The endless hot-rolled strip production method for ferrite rolling according to claim 5, wherein applicable strip is low carbon with C≤0.05%, Si≤0.10% and Mn≤0.20% in terms of percentage content or ultra-low carbon steel.

11. An endless hot-rolled strip production method for ferrite rolling using the device according to claim 2, wherein the production process comprises the steps of carrying out continuous casting to manufacture a slab, high-pressure water rotating descaling, rough rolling by the four-stand high reduction rough rolling unit, machining by the drum shear, cooling after high-pressure water descaling in the multifunctional cooling control device, finish rolling by the three-stand or four-stand finish rolling unit, air cooling, dividing coils by the high-speed flying shear, and coiling by the underground coilers, wherein temperature monitoring is respectively carried out after rough rolling, before finish rolling, after finish rolling, and before coiling by the underground coilers.

12. An endless hot-rolled strip production method for ferrite rolling using the device according to claim 3, wherein the production process comprises the steps of carrying out continuous casting to manufacture a slab, high-pressure water rotating descaling, rough rolling by the four-stand high reduction rough rolling unit, machining by the drum shear, cooling after high-pressure water descaling in the multifunctional cooling control device, finish rolling by the three-stand or four-stand finish rolling unit, air cooling, dividing coils by the high-speed flying shear, and coiling by the underground coilers, wherein temperature monitoring is respectively carried out after rough rolling, before finish rolling, after finish rolling, and before coiling by the underground coilers.

13. An endless hot-rolled strip production method for ferrite rolling using the device according to claim 4, wherein the production process comprises the steps of carrying out continuous casting to manufacture a slab, high-pressure water rotating descaling, rough rolling by the four-stand high reduction rough rolling unit, machining by the drum shear, cooling after high-pressure water descaling in the multifunctional cooling control device, finish rolling by the three-stand or four-stand finish rolling unit, air cooling, dividing coils by the high-speed flying shear, and coiling by the underground coilers, wherein temperature monitoring is respectively carried out after rough rolling, before finish rolling, after finish rolling, and before coiling by the underground coilers.
